(19) United States
(12) Patent Application Publication
(10) Pub. No.: US 2011/0150300 A1
(43) Pub. Date: Jun. 23, 2011

(54) IDENTIFICATION SYSTEM AND METHOD

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/760,441

(22) Filed: Apr. 14, 2010

(30) Foreign Application Priority Data
Dec. 21, 2009 (CN) 200910311882.2

(51) Int. Cl. G06K 9/00; H04N 7/18

(52) U.S. Cl. 382/118; 348/143; 348/E07.085

(57) ABSTRACT

An identification system includes a time-of-flight (TOF) camera and a processing unit. The TOF camera captures an image of a person, and obtains distance data between a number of points on the person and the TOF camera. The processing unit builds a current 3D model of a face of the person according to the image and the distance data, and compares the current 3D model with a number of stored 3D models to determine whether the current 3D model is the same as one of the stored 3D models, for identifying the person.

### BACKGROUND

1. Technical Field

The present disclosure relates to an identification system and an identification method.

2. Description of Related Art

Conventional identification systems that uses cameras capture two-dimensional images of the person. However, many factors, such as intensity of light, may influence performance of the cameras. As a result, the conventional identification systems are not very accurate.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of an exemplary embodiment of an identification system, the identification system includes a storage system.

FIG. 2 is a block diagram of a first embodiment of the storage system of FIG. 1.

FIG. 3 is a schematic diagram of the capturing of a person using the identification system of FIG. 1.

FIG. 4 is a block diagram of a second embodiment of a storage system of FIG. 1.

FIG. 5 is a flowchart of a first embodiment of an identification method.

FIG. 6 is a flowchart of a second embodiment of an identification method.

### DETAILED DESCRIPTION

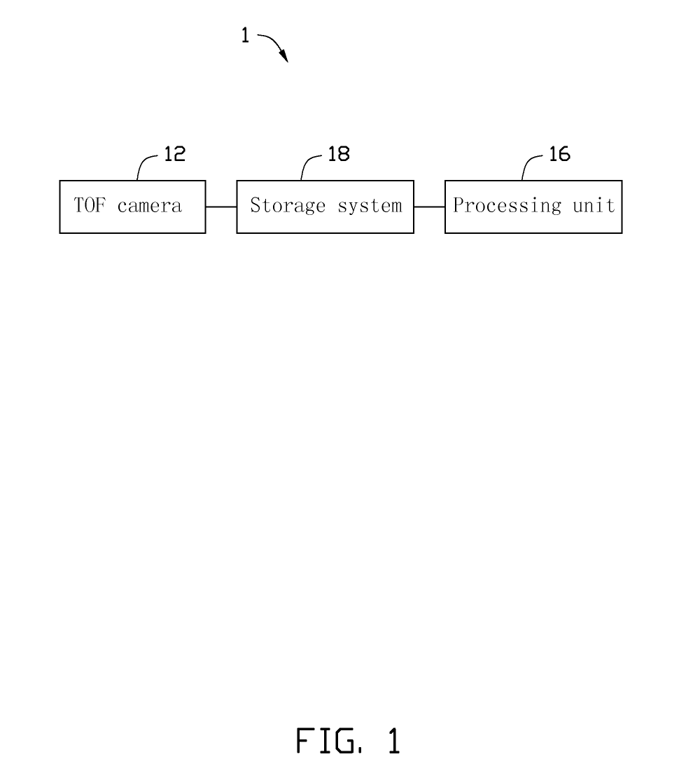

Referring to FIG. 1, an exemplary embodiment of an identification system 1 includes a time-of-flight (TOF) camera 12, a processing unit 16, and a storage system 18.

The identification system 1 obtains a three-dimensional (3D) model of a person to identify the person accurately.

The TOF camera 12 captures an image of the person. The TOF camera 12 is a camera system that obtains distance data between a plurality of points of a person and the TOF camera 12. When the TOF camera 12 films the person, the TOF camera 12 emits signals to the person. The signals are reflected back to the TOF camera 12 when they meet a body part, such as a nose of the person. As a result, the distance data can be obtained according to time differences between sending and receiving the signals of the TOF camera 12.

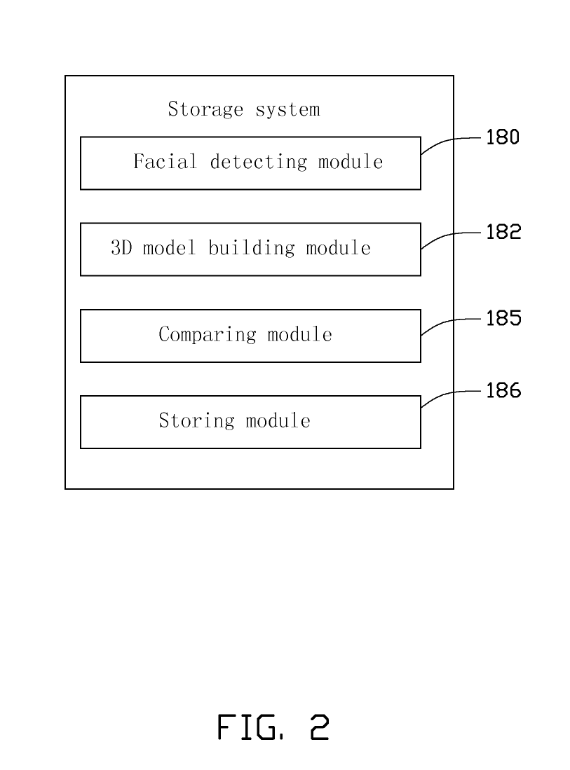

Referring to FIG. 2, a first embodiment of the storage system includes a facial detecting module 180, a 3D model building module 182, a comparing module 185, and a storing module 186. The facial detecting module 180, the 3D model building module 182, and the comparing module 185 may include one or more computerized instructions that are executed by the processing unit 16.

The facial detecting module 180 finds a face in the image from the TOF camera 12. It is noteworthy that the facial detecting module 180 uses well known facial recognition technology to find the face in the image.

The 3D model building module 182 builds a 3D model of the face of the person according to the image and the distance data. In the embodiment, the image is regarded as an X-Y plane. As a result, coordinates on the X-Y plane of the plurality of points of the person can be obtained. In addition, coordinates on a Z-axis of the plurality of points of the person can be obtained according to the distance data. Therefore, each of the plurality of points of the person has a 3D coordinate relative to the TOF camera 12. The 3D model building module 182 can build a 3D mathematical model according to the 3D coordinates of the plurality of points and the image. The 3D mathematical model is regarded as the current 3D model of the face of the person.

The storing module 186 stores a plurality of 3D models of the faces of a plurality of persons in advance. The stored 3D models can be obtained by the TOF camera 12, the facial detecting module 180, and the 3D model building module 182.

The comparing module 185 compares the current 3D model of the face of the person 50 with the stored 3D models of faces stored in the storing module 186, to determine whether the current 3D model of the face is same as one of the stored 3D models. As a result, the identification system 1 can identify the person. In the embodiment, it is noteworthy that the comparing module 185 compares the 3D mathematical models corresponding to the current 3D model and the stored 3D models to determine whether the current 3D model is same as one of the plurality of stored 3D models.

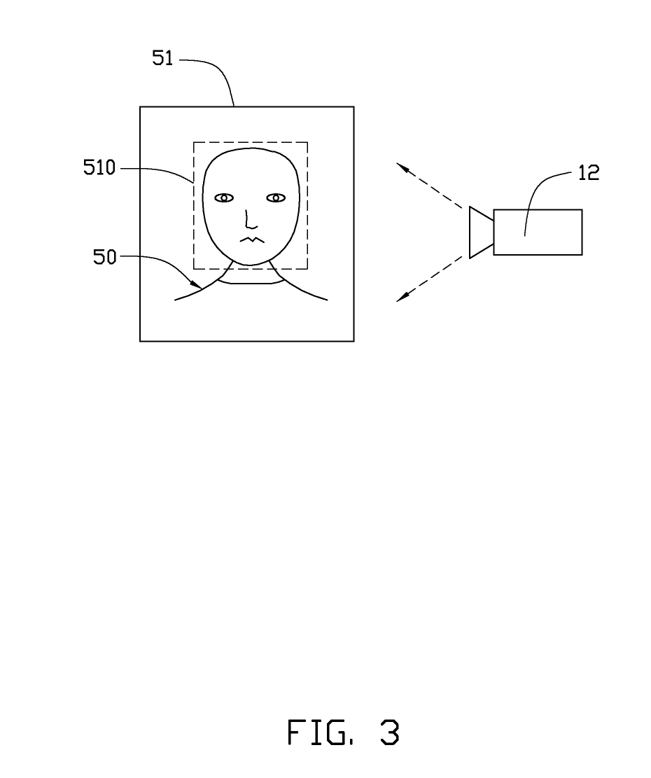

Referring to FIG. 3, the TOF camera 12 captures an image of the person 50. In addition, the TOF camera 12 emits signals to the person 50. The signals would be reflected back to the TOF camera 12 when the signals meet a body part, such as a nose of the person 50. As a result, the distance data can be obtained according to time differences between sending and receiving the signals of the TOF camera 12.

The facial detecting module 180 finds a face 510 in the image 51. The 3D model building module 182 builds a current 3D model of the face of the person 50 according to the face 510 in the image 51 and the distance data.

The comparing module 185 compares the current 3D model with the stored 3D models stored in the storing module 186 to determine whether the current 3D model is same as one of the stored 3D models, to identify the person 50.

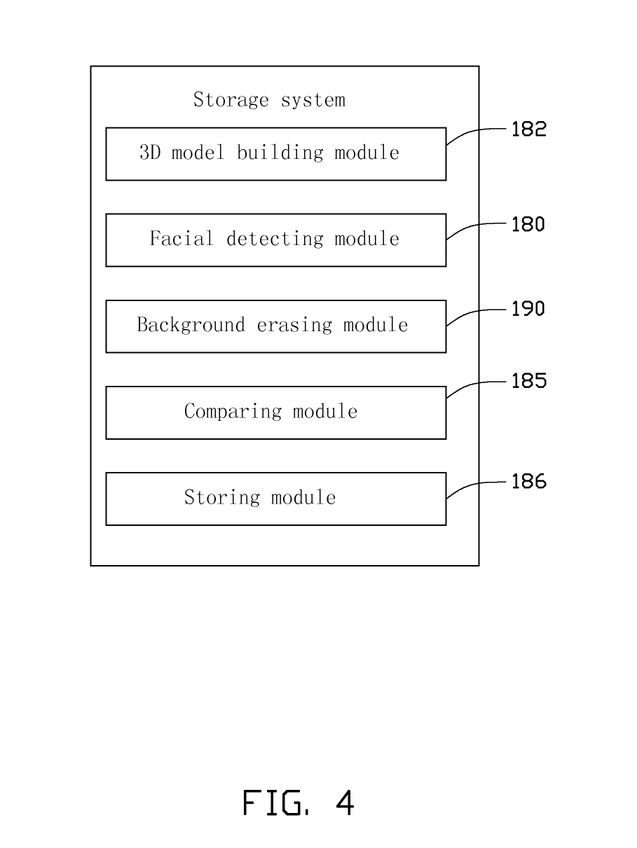

Referring to FIG. 4, a second embodiment of the storage system includes a facial detecting module 180, a 3D model building module 182, a comparing module 185, a storing module 186, and a background erasing module 190. The facial detecting module 180, the 3D building module 182, the comparing module 185, and the background erasing module 190 may include one or more computerized instructions and are executed by the processing unit 16.

The 3D model building module 182 builds a 3D model of a scene including the person and a background according to an image of the scene and distance data between a plurality of points of the scene and the TOF camera 12.

The facial detecting module 180 finds a face in the image. The background erasing module 190 erases the background and all other portions of the person 50 except the face, according to the distance data. As a result, a current 3D model of the face of the person is obtained.

The comparing module 185 compares the current 3D model of the face of the person with the stored 3D models of faces stored in the storing module 186 in advance to determine whether the current 3D model of the face of the person is same as one of the stored 3D models, to identify the person.

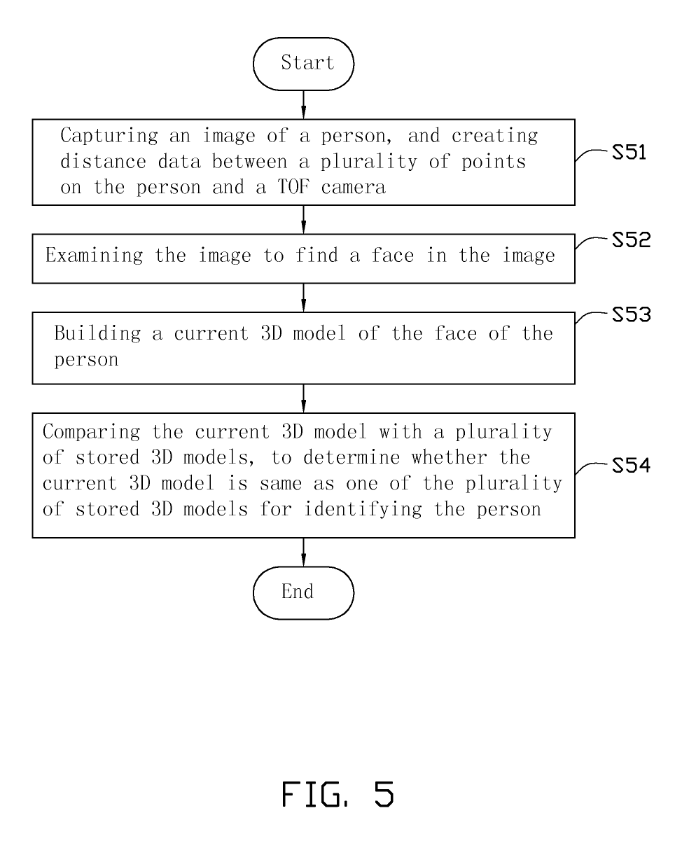

Referring to FIG. 5, a first embodiment of an identification method includes the following steps.

In step S51, the TOF camera 12 captures an image of a person, and obtains distance data between a plurality of points of the person and the TOF camera 12. The TOF camera 12 is a camera system that obtains distance data between the plurality of points of the person and the TOF camera 12. When the TOF camera 12 films the person, the TOF camera 12 sends signals to the person. The signals return to the TOF camera 12 when they meet a body part, such as a nose of the person. As a result, the distance data can be obtained according to time differences between sending and receiving the signals of the TOF camera 12.

In step S52, the facial detecting module 180 finds a face in the image. It is noteworthy that the facial detecting module 180 uses well known facial recognition technology to find the face in the image.

In step S53, the 3D model building module 182 builds a current 3D model of the face of the person according to the image and the distance data. In the embodiment, according to the distance data and the image, a 3D coordinate of each of the plurality of points relative to the TOF camera 12 is obtained. As a result, a 3D mathematical model is obtained as the current 3D model of the face of the person according to a plurality of 3D coordinates.

In step S54, the comparing module 185 compares the current 3D model of the face of the person 50 with the stored 3D models stored in the storing module 186, to determine whether the current 3D model is the same as one of the stored 3D models. As a result, it can identify the person. In the embodiment, it is noteworthy that the comparing module 185 compares the 3D mathematical models corresponding to the current 3D model of the face of the person and the plurality of stored 3D models to determine whether the current 3D model of the face of the person is same as one of the plurality of stored 3D models.

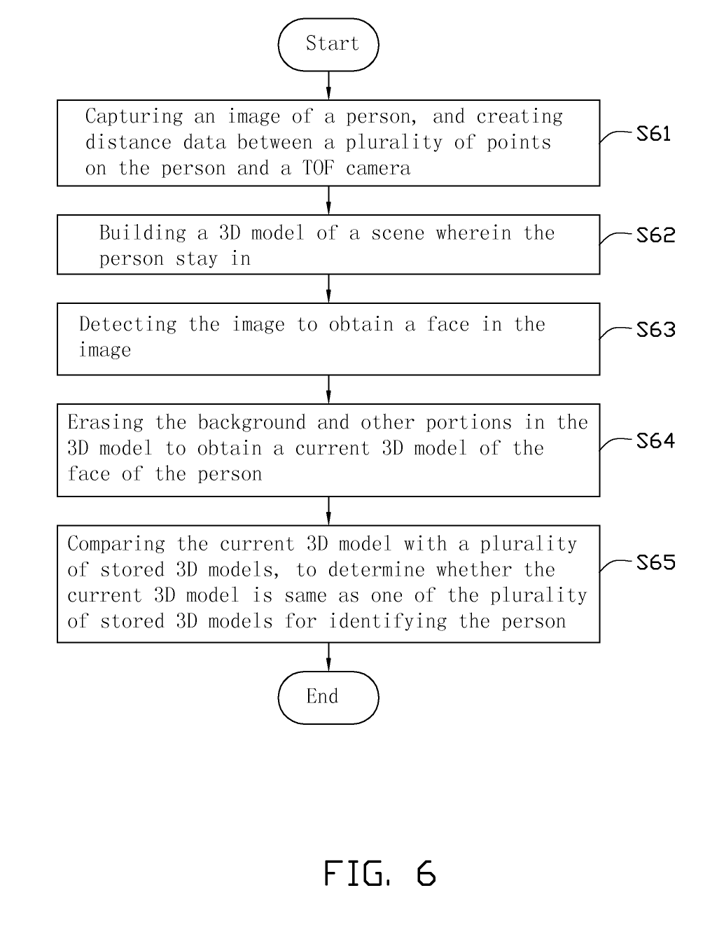

Referring to FIG. 6, a second embodiment of an identification method includes the following steps.

In step S61, the TOF camera 12 captures an image of a person, and obtains distance data between every point of the person and the TOF camera 12. The TOF camera 12 is a camera system that obtains the distance data. When the TOF camera 12 films the person, the TOF camera 12 emits signals to the person. The signals are reflected back to the TOF camera 12 when they meet a body part, such as a nose of the person. As a result, the distance data can be obtained according to time differences between sending and receiving the signals of the TOF camera 12.

In step S62, the 3D model building module 182 builds a current 3D model of a scene including the person and a background.

In step S63, the facial detecting module 180 detects a face in the image.

In step S64, the background erasing module 190 erases the background and all other portions of the person except for the face, according to the distance data. As a result, a current 3D model of the face of the person can be obtained.

In step S65, the comparing module 185 compares the current 3D model with the stored 3D models stored in the storing module 186 to determine whether the current 3D model of the face of the person is same as one of the stored 3D models, to identify the person.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. An identification system comprising:
a time-of-flight (TOF) camera to capture an image of a person and obtain distance data between a plurality of points on the person and the TOF camera;
a processing unit;
a storage system connected to the processing unit and storing a plurality of programs to be executed by the processing unit, wherein the storage system comprises:
a facial detecting module to find a face in the image;
a three dimension (3D) model building module to build a current 3D model of the face according to the image and the distance data;
a storing module to store a plurality of 3D models of faces of a plurality of persons in advance; and
a comparing module to compare the current 3D model of the face with the stored 3D models to determine whether the current 3D model of the face is same as one of the stored 3D models to identify the person.

2. The identification system of claim 1, wherein a 3D coordinate relative to the TOF camera of each point of the plurality of points is obtained, and the 3D model building module builds a 3D mathematical model as the current 3D model of the face according to the 3D coordinates.

3. An identification system comprising:
a time-of-flight (TOF) camera to capture an image of a scene comprising a person and a background, and obtain distance data between a plurality of points on the scene and the TOF camera;
a processing unit;
a storage system connected to the processing unit and storing a plurality of programs to be executed by the processing unit, wherein the storage system comprises:
a three dimension (3D) model building module to build a 3D model of the scene according to the image and the distance data;
a facial detecting module to find a face of the person in the image;
a background erasing module to erase the background and other portions of the person except the face according to the distance data, to obtain a current 3D model of the face of the person;
a storing module to store a plurality of 3D models of faces of a plurality of persons in advance; and
a comparing module to compare the current 3D model of the face with the stored 3D models to determine whether the current 3D model of the face is same as one of the stored 3D models of the faces, to identify the person.

4. The identification system of claim 3, wherein a 3D coordinate relative to the TOF camera of each point of the plurality of points is obtained, and the 3D model building module builds a 3D mathematical model as the current 3D model of the face according to the 3D coordinates.

5. An identification method comprising:
capturing an image of a person and obtaining distance data between a plurality of points on the person and a time-of-flight (TOF) camera by a TOF camera;
building a current three-dimension (3D) model of a face of the person according to the image and the distance data; and
comparing the current 3D model of the face with a plurality of 3D models of faces of a plurality of persons stored to determine whether the current 3D model is same as one of the stored 3D models.

6. The identification method of claim 5, wherein the step of building the 3D model of a face of the person comprises:
finding a face in the image; and
building the current 3D model of the face according to the face in the image and the distance data.

7. The identification method of claim 6, wherein the step of building the 3D model of the face of the person comprises:
obtaining a 3D coordinate relative to the TOF camera of each point of the plurality of points; and
building a 3D mathematical model as the current 3D model of the face according to the 3D coordinates.

8. The identification method of claim 5, wherein the step of building the 3D model of a face of the person comprises:
building a 3D model of a scene comprising the person and a background according to the image and the distance data;
detecting a face in the image; and
erasing the background and other portions of the person except the face according to the distance data, to obtain the current 3D model of the face.
